(19) United States
(12) Patent Application Publication
(10) Pub. No.: US 2007/0043530 A1
(43) Pub. Date: Feb. 22, 2007

(54) Pill bottle sticker system and method

(76) Inventor: Ian O'Rourke, San Rafael, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/206,897

(22) Filed: Aug. 18, 2005

(51) Int. Cl. G04F 8/00

(52) U.S. Cl. 702/177

(57) ABSTRACT

A method for identifying the timing and quantity of medicine to be taken by a patient; determining the quantity of a medicine to be taken by a patient and the time of day the medicine is to be taken; generating a plurality of stickers to be placed on the medicine container, the stickers having a first indicator referencing a time of day and a second indicator indicating the quantity of a medicine; and placing the stickers on the medicine container.

### FIELD OF THE INVENTION

The present invention is directed to the field of medicine safety and dosage control. In particular, the present invention discloses a sticker system and method which provides dosage and using colors, numbers and shapes.

### BACKGROUND OF THE INVENTION

Controlling medication dosage and timing is a critical factor in proper medical treatment. Studies have shown that a large number of accidental overdoses are directly related to patients not taking the proper dosages as prescribed. Failure to take correct and timely dosages has been recognized as one of the critical causes of side effects in the use of cholesterol, arthritis and diabetic related medications. Often dosage and daily timing requirements are set forth in small print on bottles or inserts accompanying the dosage which are often misplaced or discarded This can be particularly difficult for the illiterate, for the aged population and for people in the United States for whom English, for example, is not their principal language.

A number of patents have issued in the area of assisting patients in the proper and timely taking of medication U.S. Pat. No. 5,393,100 discloses a support which carries a pad of medicine schedules and a pad of medicine display cards. Each medicine schedule has a place for a medication sticker with a picture of the tablet or other medication involved, and space for instructions concerning that medication. Each display card carries multiple stickers of a single medication. An individual sticker can be lifted from the card and placed on the medicine schedule. A physician writes instructions concerning the medicine. The patient is provided with the medicine schedule and thus has a graphic indication of which medicine must be taken and the instructions concerning that medicine.

U.S. Pat. No. 4,815,767 discloses a chart which is divided into sections representing different times of day and days of the week for providing a space to indicate and document when medication should be taken as well as to indicate if the medication has been taken. A plurality of sets of different distinctively shaped and colored stickers are provided which are clearly visibly distinguishable one set from the other sets. A selected set of stickers is chosen for each medication which is to be taken and the sticker from that set is affixed on the chart on the appropriate day and time as prescribed by the user's doctor. At the same time, the same shaped sticker from that selected set is affixed on the prescription container. By matching the shape of the sticker on the bottle with the shape of the sticker on the chart, the medication to be taken is clearly identified at specific times of the day, and when it is taken a mark is placed in the section of the chart next to the sticker indicating the time and day on which it is taken to provide a permanent record of what medication is taken as well as when. By using a different set of stickers of each type of medication a system is provided for reminding the patient of the type of medication which is to be taken, when it is to be taken as well as providing a permanent record when it is taken.

U.S. Pat. No. 5,261,702 discloses a chart listing medications, dosage times, and notes. U.S. Pat. No. 4,941,688 discloses a period event recorder comprising a label, indicia on the label corresponding to a desired time or frequency interval; a porous substrate attached to the underside of the label; means for attaching the porous substrate to an object associated with, related to, or nearby the site for performance of a desired task or event; and a stylus adapted to puncture that portion of the label bearing indicia corresponding to that particular performance of the desired task or event.

U.S. Pat. No. 6,769,545 discloses a medication management system uses a container that holds all medicine bottles wherein the medicine stored therein is taken on the same time schedule. A peg is placed into an opening located on the container wherein a label that has printing thereon that corresponds to the time of the current medicine consumption located proximate the opening wherein the peg is placed. The peg is moved after the satisfaction of each time within the schedule. Multiple containers are provided, each having a labeling system that corresponds to the time regiment of the medicines being stored within the particular container.

U.S. Pat. No. 5,758,096 discloses a computer-based system and method for generating a medication management display comprises entering a plurality of medication names prescribed for one or more patients, with corresponding strength attributes, and alpha-numeric medication symbol attributes, into an electronic data base. An electronically stored correlation list is then accessed to associate the alpha-numeric symbol attributes to graphic symbols. This information is arranged to generate a patient medication chart displaying one or more medication names associated with its corresponding strength, directions, and graphic symbol. Adhesive graphic symbols are applied to the original medication containers that hold the medications to cross reference the actual medications with the chart. The patient medication data may also include administration comments with at least one medication which is visually displayed.

U.S. Pat. No. 5,102,169 discloses a chart listing medications, dosage times, and notes. Tactile and visual medication symbols and marking elements denote specific times for taking specific medications. Medication containers are similarly marked.

U.S. Pat. No. 6,685,227 discloses an arrangement of pharmaceutical labels in a sheet and to a method of monitoring administration of the pharmaceuticals to a patient using those labels. The labels may include indicia to assist transferal of information and/or to a label including information to assist in the administration by infusion of a pharmaceutical to a patient.

U.S. Pat. No. 5,995,938 discloses a medication compliance system having an output device; and a computer in communication with the output device and having loaded therein a computer program to define a particular logic circuit which generates a graphical user interface with which a user indicates the number of times a particular pharmaceutical is to be taken during a day, and which causes the output device to print a label having data thereon identifying the pharmaceutical, and having a shape thereon representing the number of times a day, or the particular time of day the pharmaceutical is to be taken.

U.S. Pat. No. 5,431,450 discloses a chart or a board listing medications, dosages and times to be taken, and notes. There is a medication recessed tray that organizes the user's medicines into one central location. The frequency denotes how frequently a medication is to be taken. Medication name column is where the name of the medication is placed, the type of medication, and the dosage and the usage. The calendar section, labeled Sunday-Saturday, which has square boxes that are to have check marks placed in them only after medication is ingested or applied. Refill column, where refill dates and other refill information is placed. The dot on the refill column is to be colored in if a doctor's visit is required before medication can be refilled. The pertinent medical information column is where the patient can place any information that he or she finds useful. The surface of the board is dry continuous basis. The board is to be marked by a marker.

U.S. Patent Application No. 20040088132 discloses a “medication communicator” chart is used as a teaching tool to educate patients and to schedule events corresponding to a prescribed medication regimen. The “medication communicator” chart includes a scheduling graph having the shape of a 12-hour or 24-hour analog clock. The scheduling graph is divided into regions corresponding to each hour of a day for scheduling event information. Fields, on the “medication communicator” chart, are receptive to labels communicating information corresponding to numerous medications in the medication regimen. Timing indicators may be applied to the regions of the scheduling graph to indicate consumption or application times of each of the medications.

U.S. Patent Application No. 20030025320 discloses a medicine receptacle label apparatus and method is proposed. The labeling system includes the placement of an iconic label upon the exterior of a medicine receptacle to graphically assist the patient in taking the proper medication. The iconic labels include descriptive icons that graphically depict either the symptoms or desired result for which the medicine contained therein is to be taken, among others. The present invention will assist the elderly and vision impaired the most, enabling them to select and consume their medications properly.

U.S. Patent Application No. 20020153411 discloses a medicine cabinet or similar device that assists users in selecting and taking medication. A radio frequency receiver is configured to read information included on radio frequency sensitive labels that are attached to items containing medication in the medicine cabinet. A computer in the medicine cabinet is operatively connected to the radio frequency receiver and also to a wide area network, such as the Internet. The medicine cabinet has a display device that is operatively coupled with the computer and, in the form of a touch screen flat panel, the display device functions to interface the user and the medicine cabinet. The computer is configured to transmit information to the Internet and receives information from websites or additional computers that are coupled to the Internet. Information regarding medications and users as well as vital signs records of the users are stored either in the memory of the medicine cabinet or at a remote location via the connection to the Internet.

While there have been a number of prior art systems for assisting patients in taking medicines, there has not been a simple sticker system which may be affixed to the container and which can be easily put to use and universally understood. Most of the prior art systems involve the use of additional apparatus such as charts or pill holding apparatuses. These devices may themselves be difficult to use and confuse the elderly.

It is an object of the present invention to provide a system whereby stickers can be attached to medicine bottles.

It is a further object of the present invention to provide a system in which medicine bottles are included with a universal sticker system which is easy to use and is independent of language knowledge.

### SUMMARY OF THE INVENTION

In accordance with the invention, a method for identifying the timing and quantity of medicine to be taken by a patient comprising; determining the quantity of a medicine to be taken by a patient and the time of day the medicine is to be taken; generating a plurality of stickers or printed symbols to be placed on the medicine container, the stickers having a first indicator referencing a time of day and a second indicator indicating the quantity of a medicine; and placing the stickers on the medicine container or included on the prescription label.

In a further embodiment, the present invention is a universal method for identifying the timing and quantity of medicine to be taken by a patient determining the quantity of a medication to be taken by a patent and the times of the day the medicine is to be taken; generating a plurality of stickers to be placed in the medicine containers, the stickers having different geometric shapes, each shape corresponding to a time of day, said sticker further having a numerical indicator referencing dosage the stickers may be printed in Braille to accommodate the visually impaired.

In yet a further embodiment, the present invention is a computerized system for generating a medical label with time and dosage indications comprising: a user interface under the control of a program for permitting an end user to input time and dosage requirements for a prescription or non-prescription medication; and a printer under the control of the program for printing out a label in which the time requirements of the medication comprise at least one geometrically shaped symbol and the dosage requirements comprise a numerical value printed within the symbol

### DESCRIPTION OF THE FIGURES

FIG. 1 is a perspective view of the pill bottle stickers of the present invention.

FIGS. 2 and 3 are perspective views of the present invention affixed onto a pill bottles.

FIG. 4 is a block diagram of a computer generating label system.

FIG. 5 is a computer generated label.

### DETAILED DESCRIPTION OF THE PREFERRED EMBODIMENT

The present invention is now described with reference to the enclosed figures wherein the same numbers are used where applicable. The present invention is directed to a system for creating and placing stickers or printed symbols on medicine bottles in order to insure patients take the proper quantity at the proper time.

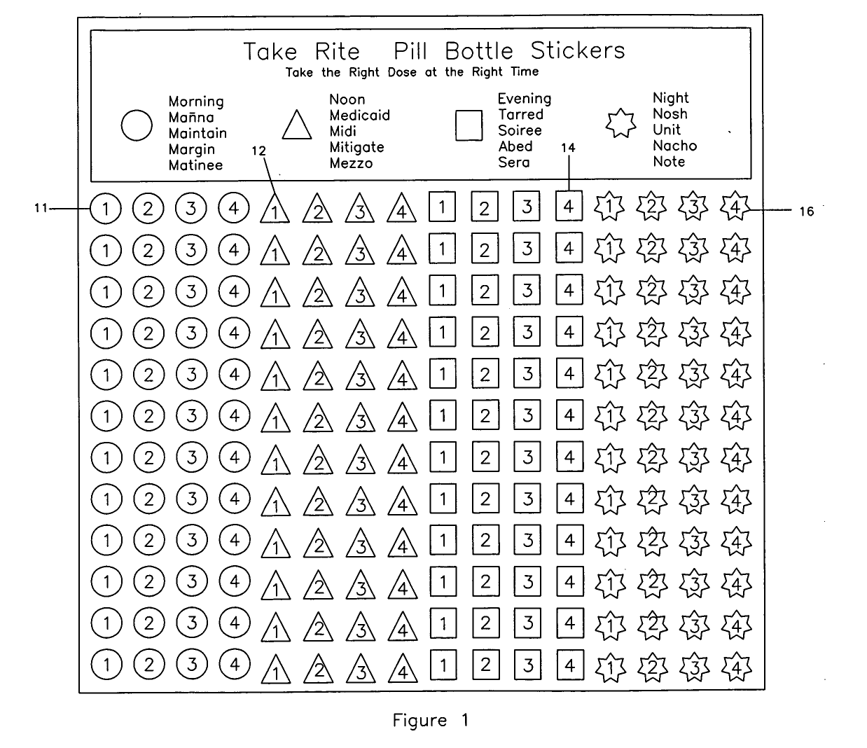

The critical feature of the invention is a configuration of shaped stickers with numbers and/or colors. Referring to FIG. 1, in one embodiment, the invention comprises four types of shaped stickers. In the embodiment, the first types of sticker 11 is circular, the second types of sticker is triangular 12, the third types of sticker is square 14 and the final types of sticker is star shaped 16. The circular sticker 11 represents morning, the triangular sticker 12 represents noon, the square sticker 14 represents evenings, and the star sticker 16 represents nighttime. Each of the shaped stickers also has a numbers from 1 to 4. These numbers correspond to the quantity of medication that the patient is expected to take at a particular time of day. The stickers may also have a color scheme wherein a circular sticker 11 is yellow, a triangular sticker 12 is green, a square sticker 14 is blue, and a star shaped sticker 16 is black.

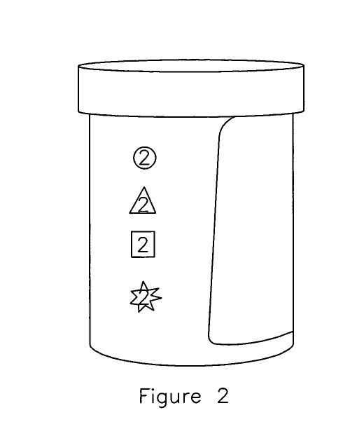

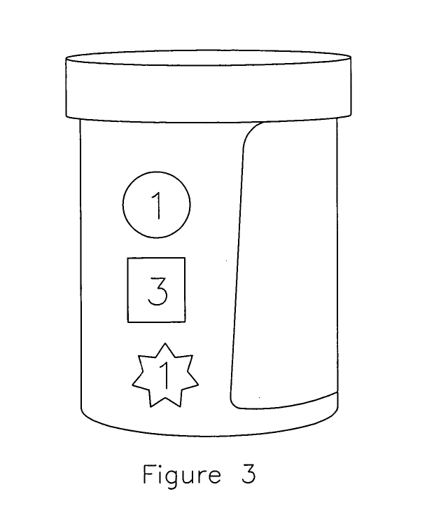

For example, a circular sticker on the medicine bottle with the number 2 printed on it, such as depicted in FIG. 2, indicates that two capsules/pills/tablets are to be taken in the morning. The addition of a star sticker with the number 2 means that two capsules/pills/tablets are also to be taken at night before bed. FIGS. 2 and 3 illustrate a variety of sticker configurations indicating the time and dosage of medication.

While the present invention is described in the context of one embodiment of shapes and colors, it is to be appreciated that a plurality of color and shape schemes are suggested by the present invention.

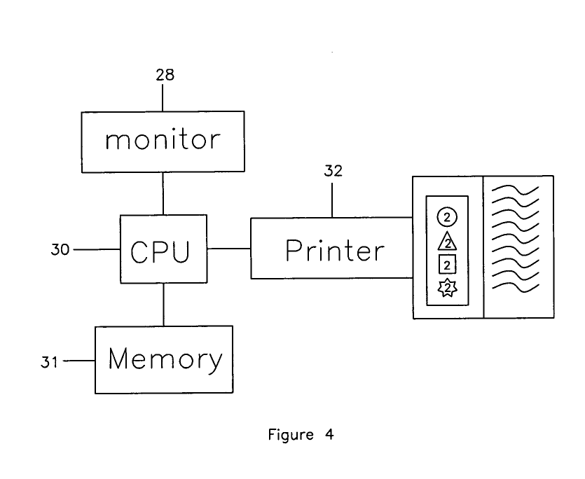

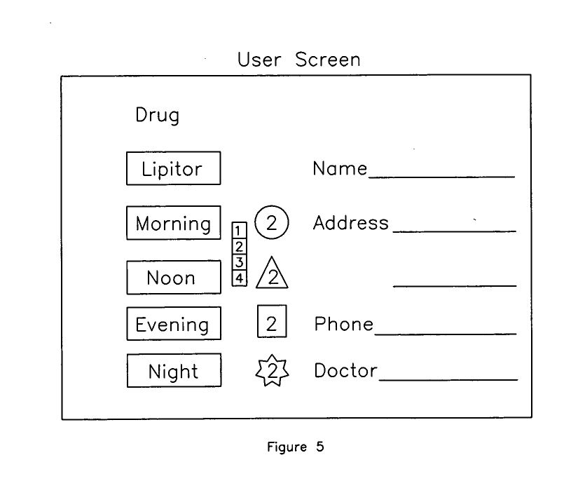

The present invention provides a simple method whereby stickers indicating proper dosage and time can be placed on a bottle of medicine. The invention suggests a number of alternatives. In a more preferred embodiment, the invention comprises a software system which automatically generates a label or is included in a prescription label to be placed on a bottle. This embodiment includes a monitor 20, CPU 30 and printer 32 as depicted in FIG. 4. Under a program stored in a memory 31, a pharmacist can input information concerning the medicine in a user screen, including time and frequency, either manually or from a pull down screen. FIG. 5 depicts the label generated b the software system of Figure

1. A method for identifying the timing and quantity of medicine to be taken by a patient;
determining the quantity of a medicine to be taken by a patient and the time of day the medicine is to be taken;
generating a plurality of stickers to be placed on the medicine container, the stickers having a first indicator referencing a time of day and a second indicator indicating the quantity of a medicine; and placing the stickers on the medicine container.

2. The method of claim 1 wherein the time of day indicator is a shape.

3. The method of claim 1 wherein the time of day indicator is a color.

4. The method of claim 1 wherein the quantity indicator is a numerical indicator.

5. A universal method for identifying the timing and quantity of medicine to be taken by a patient
determining the quantity of a medication to be taken by a patent and the times of the day the medicine is to be taken;
generating a plurality of stickers to be placed in the medicine containers, the stickers having different geometric shapes, each shape corresponding to a time of day, said sticker further having a numerical indicator referencing dosage;

6. A computerized system for generating a medical label with time and dosage indications comprising:
a user interface under the control of a program for permitting an end user to input time and dosage requirements for a prescription or non-prescription medication; and
a printer under the control of the program for printing out a label in which the time requirements of the medication comprise at least one geometrically shaped symbol and the dosage requirements comprise a numerical value printed within the symbol
